(19) United States
(12) Patent Application Publication
(10) Pub. No.: US 2011/0244297 A1
(43) Pub. Date: Oct. 6, 2011

(54) PRISMATIC-CELL BATTERY PACK WITH INTEGRAL COOLANT CHANNELS

(75) Inventors: DUANE D. KRUGER, WESTFIELD, IN (US); ROBERT C. BEER, NOVLESVILLE, IN (US)

(73) Assignee: DELPHI TECHNOLOGIES, INC., TROY, MI (US)

(21) Appl. No.: 13/118,799

(22) Filed: May 31, 2011

Related U.S. Application Data
(63) Continuation-in-part of application No. 12/611,168, filed on Nov. 3, 2009.

(51) Int. Cl. H01M 10/50

(52) U.S. Cl. 429/120

(57) ABSTRACT

A prismatic-cell battery pack is provided with integral coolant passages and a distributed array of coolant channels coupled between an intake plenum and a pair of exhaust plenums. Coolant medium forced into the intake plenum draws heat away from the battery cells, and then exits via the exhaust plenum for expulsion of heat into the atmosphere. The battery pack is configured as a set of stackable interlocking battery cell modules including at least one battery cell in thermal proximity to an array of coolant channels distributed over the profile of the battery cell, and a pair of peripheral chambers joined to opposite ends of the coolant channels to form the intake and exhaust plenums when the modules are arranged and interlocked in a lineal stack. The entry end of each channel is closer to a centerline of the battery cell than the exit end of the channel.

### CROSS-REFERENCE TO RELATED APPLICATION

This application is a continuation-in-part application and claims the benefit of U.S. patent application Ser. No. 12/611,168, filed on Nov. 3, 2009, the entire disclosure of which is hereby incorporated herein by reference.

### TECHNICAL FIELD OF INVENTION

The present invention relates to a high-voltage battery pack containing prismatic battery cells arranged in a lineal stack, and more particularly to a prismatic-cell battery pack with integral coolant passages for forced convection cooling of the battery cells.

### BACKGROUND OF INVENTION

High voltage battery packs can be configured for efficient space utilization by stacking and co-packaging battery cells of a prismatic (i.e., rectangular) form factor. The prismatic cells are typically arranged so that their terminals are all accessible from the top of the pack, and the terminals of adjacent cells lie in close proximity for convenient interconnection due to the thin profile of the cells. Lithium-ion batteries are well-suited to such applications because of their low weight, high power density and relatively high cell voltage, and because they can be produced at relatively low cost in prismatic form, particularly when encapsulated by a soft package of metalized plastic film instead of a rigid plastic or metal case. When soft-package cells are used, they can be conveniently mounted in stackable rigid plastic frames, as shown for example, in the U.S. Patent Publication No. 2006/01232119. Also, foam pads can be used for cell-to-cell isolation and to compressively support the cells.

A serious challenge involved in the design of a battery pack is the provision of adequate cooling for the individual cells. This is particularly true in hybrid vehicle and other applications that require the battery pack to supply large amounts of energy at a high rate. The usual approach is to attach one or more liquid-cooled or air-cooled heat sinks to the bottom and/or sides of the battery pack, and to use metal heat runners to transfer heat from the battery cells to the heat sinks by conduction. While this approach can be effective if sufficient space is available to accommodate the heat sinks, space and weight considerations often take precedence, forcing sub-optimal sizing and placement of the heat sinks. Moreover, the effectiveness of this approach is hampered for two additional reasons: first, the heat produced in a battery cell causes the greatest temperature rise near the terminals, which may be separated from the heat sinks by a substantial distance; and second, the cooling medium rises in temperature as it travels through the heatsink, which degrades heat rejection capability at the downstream end of the heatsink. Since over-heating can permanently damage a battery cell, the power output of the battery pack is often limited to extend battery pack life expectancy. Accordingly, what is needed is a way to more effectively and uniformly cool a prismatic-cell battery pack so that reliability and performance can be improved.

### SUMMARY OF THE INVENTION

The present invention is directed to an improved prismatic-cell battery pack having integral coolant passages including an intake plenum, an exhaust plenum, and a distributed array of coolant channels coupled between the intake plenum and the exhaust plenum. A coolant medium such as air is forced into the intake plenum, enters the various coolant channels in parallel, draws heat away from the battery cells, and then enters the exhaust plenum and so removes heat from the battery cell.

The improved battery pack is conveniently configured as a set of stackable interlocking battery cell modules, where each module supports at least one prismatic battery cell in thermal proximity to an array of coolant channels distributed over the profile of the battery cell. Each battery cell module also includes peripheral chambers joined to opposite ends of the coolant channels to form the intake and exhaust plenums when the modules are arranged and interlocked in a lineal stack. In a preferred mechanization, the intake and exhaust plenums are disposed below the battery cells, and the coolant channels are in the shape of an inverted-U, conducting coolant from the intake plenum, upward across the central portion of the battery cell toward the battery cell terminals, outward away from the vertical centerline of the battery cell, and then back downward to enter the exhaust plenums.

In accordance with one embodiment of this invention, a prismatic-cell battery pack is provided. The prismatic-cell battery pack includes a set of battery cell modules arranged and interlocked in a lineal stack. Each battery cell module includes at least one prismatic battery cell supported in thermal contact with one or more coolant channels distributed over a profile surface of the battery cell. Each battery cell also includes a plurality of peripheral chambers joined to opposite ends of the coolant channels that are configured to form an intake plenum and a pair of exhaust plenums that are, respectively, upstream and downstream of the coolant channels when the modules are lineally arranged and interlocked. Each coolant channel defines an entry end coupled to the intake plenum and one or more exit ends coupled to one or both of exhaust plenums. Coolant supplied to the intake plenum enters the entry end of a channel and is returned to one or more exhaust plenums via one or more exit ends for expulsion of heat from the battery pack and thereby cools the respective battery cells. The one or more coolant channels are configured such that the entry end is closer to a centerline of the battery cell than the exit end.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an perspective view of a prismatic-cell battery pack according to this invention;

FIG. 2 is an perspective view of a battery cell module of the battery pack of FIG. 1;

FIG. 3 is a partially sectioned perspective view of the battery pack of FIG. 1, illustrating coolant flow through a representative battery cell module;

FIG. 4 is an abbreviated coolant flow diagram for the battery pack of FIG. 1;

FIG. 5 is a partial cross-sectional view illustrating inlet and outlet end caps for the battery pack of FIG. 1; and

FIG. 6 is an exploded perspective view of the battery cell module of FIG. 2.

### DETAILED DESCRIPTION OF INVENTION

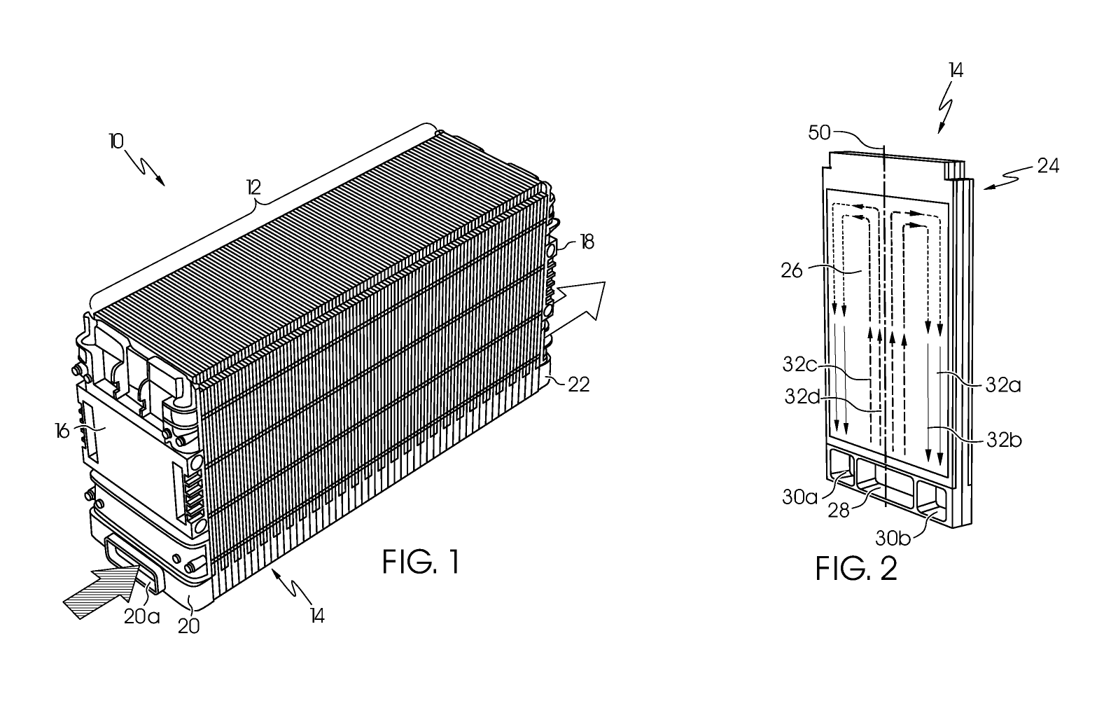

Referring to the drawings, and particularly to FIGS. 1-3, the reference numeral 10 generally designates prismatic-cell battery pack according to this invention. In general, the battery pack 10 includes a lineal stack 12 of battery cell modules 14 longitudinally bounded by first and second end pieces 16 and 18, an inlet end cap 20, and an outlet end cap 22. Referring particularly to FIG. 2, each of the battery cell modules 14 includes a set of interlocking frames 24 for supporting and retaining a pair of prismatic battery cells 26 (only one of which is shown in FIG. 2), and for channeling coolant in proximity to the battery cells 26. The battery cells 26 are preferably soft-package cells, and a pad of resilient material such as open-cell foam (not shown) is inserted between each of the battery cell modules 14 of the stack 12 to support and compressively load the non-marginal portions of the battery cells 26. The battery pack elements may be held in place, for example, by a set of fasteners routed through suitable openings (not shown) in the modules 14 and end pieces 16, 18.

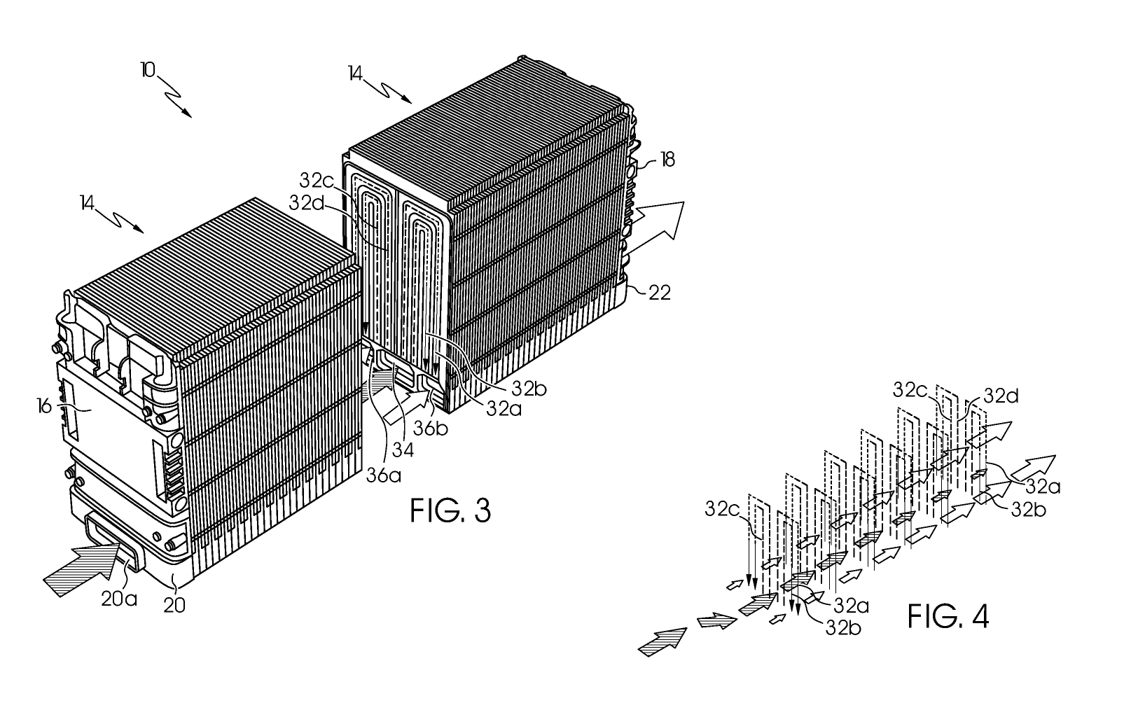

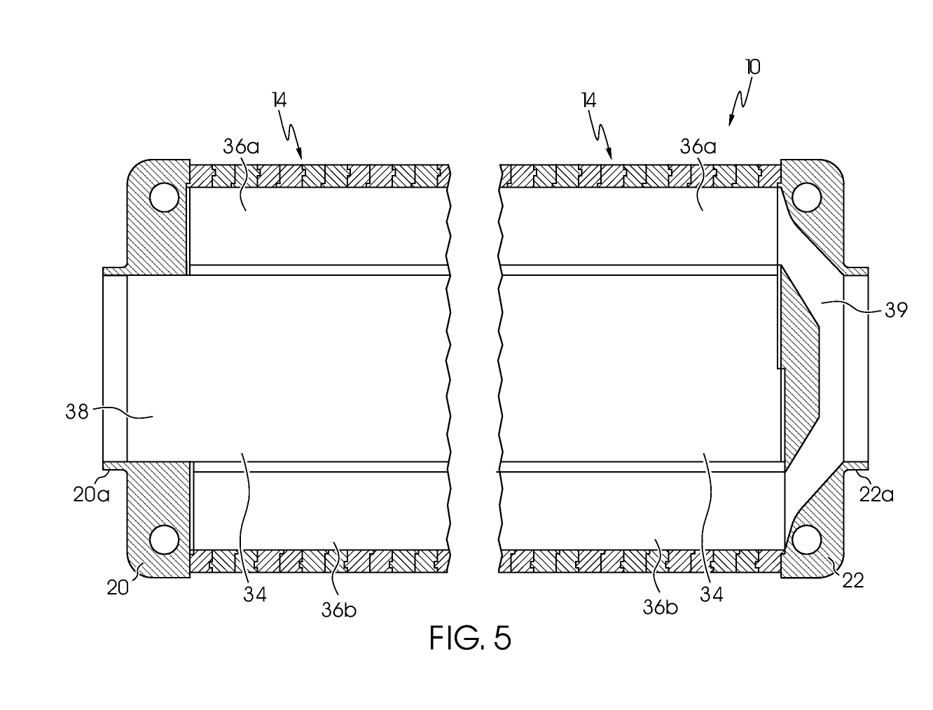

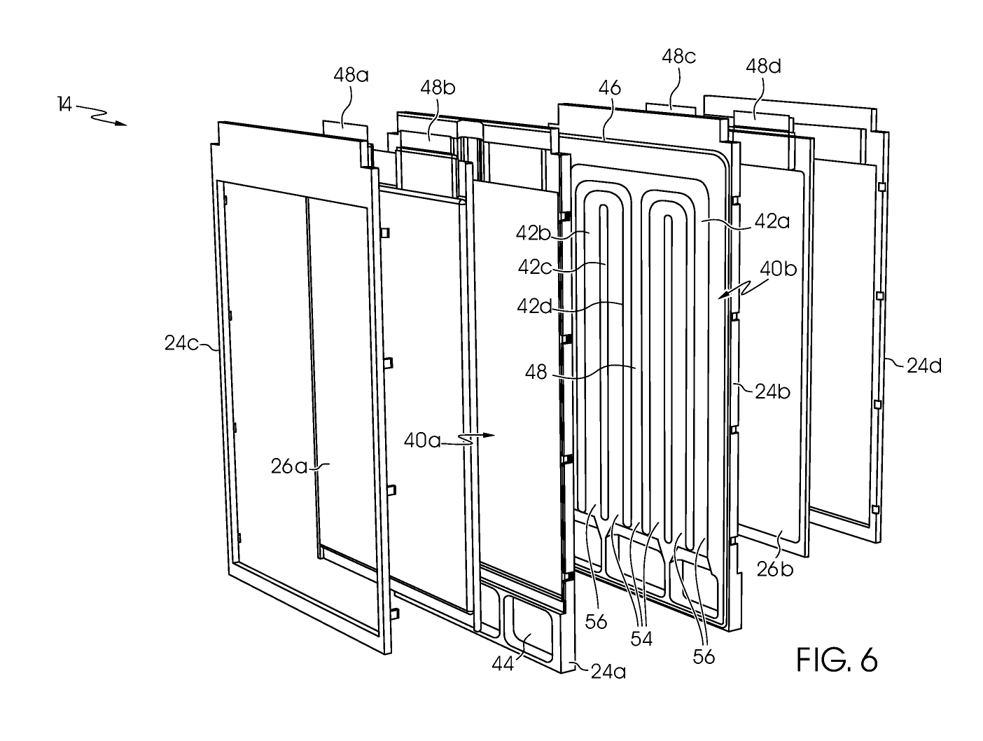

Referring to FIG. 2, each of the battery cell modules 14 includes a set of coolant passages, including an intake chamber 28, an exhaust chambers 30A and 30B, and several U-shaped coolant channels 32a, 32b, 32c, 32d (as represented by phantom flow lines) that couple an entry end 54 (FIG. 6) of each coolant channel to the intake chamber 28, and couple an exit end 56 (FIG. 6) of each coolant channel to the exhaust chambers 30A or 30B. When the battery cell modules 14 are arranged and interlocked in a lineal stack as shown in FIGS. 1 and 3, the various intake chambers 28 axially align to form an intake plenum 34 that extends the length of the stack 12, and the various exhaust chambers 30A and 30B similarly align to form a pair of exhaust plenums 36A and 36B that also extends the length of the stack 12. As illustrated in FIG. 5, the coolant inlet cap 20 blocks the exhaust plenums 36A and 36B, and establishes a pathway 38 between intake plenum 34 and an inlet port 20a formed in the coolant inlet cap 20. Conversely, the coolant outlet cap 22 blocks the intake plenum 34 but establishes a pathway 39 between exhaust plenums 36A and 36B and an outlet port 22a formed in the coolant outlet cap 22. Accordingly, and as illustrated in the coolant flow diagram of FIG. 4, coolant (forced air, or fluid for example) entering inlet port 20a is directed into the intake plenum 34, through the U-shaped coolant channels 32a-32d in each of the stacked battery cell modules 14, into the exhaust plenums 36A and 36B, and is expelled from the outlet port 22a.

The temperature of the coolant entering each of the battery cell modules 14 is essentially the same because each module 14 receives coolant from the intake plenum 34, as opposed to coolant that has already passed through another module 14 of the pack 10. As a result, the cooling performance is substantially equivalent for each battery cell module 14 of the pack 10. Additionally, the U-shaped coolant channels 32a-32d traverse substantially the entire surface area of the respective battery cells 26 to prevent any battery cell hot-spots, particularly in the region of the battery terminals where much of the battery cell heat is generated. Furthermore, by routing coolant first toward a central portion of the battery cell, that is nearby or along a centerline 50 of the battery cell, where the greatest temperature rise has been observed with other coolant channel configurations, the range of temperature variation across the battery cell may be reduced. While the temperature of the coolant flowing into the entry end 54 of each coolant channels 32a-32d will obviously rise as it traverses up the U-shaped coolant channels 32a-32d, the coolant flow can be controlled to provide sufficient cooling to the battery cell portions adjacent the exit ends 56 of the coolant channels 32a-32d. Also, the coolant channels 32a, 32b, 32c, 32d in a given battery call module 14 can vary in width to achieve a desired coolant flow distribution for optimal cooling performance.

Referring to FIG. 6, each of the battery cell modules 14 is constructed as an assembly of two prismatic battery cells 26a, 26b and a set of four interlocking frame members 24a-24d. In this non-limiting example, the two inner frame members 24a and 24b are identical, as are the two outer frame members 24c and 24d. Although not shown in FIG. 6, the modules 14 may include a provision for suitably interconnecting the battery cell terminals 48a, 48b, 48c, 48d, and the battery cells 26a, 26b may be placed in an orientation that facilitates the desired series or parallel battery terminal interconnection.

The two inner frame members 24a and 24b each have a planar outboard face 40a and sculpted inboard face 40b. When they are arranged as shown in FIG. 6 and mutually joined, the outboard faces 40a provide smooth support surfaces for the battery cells 26a and 26b, and the sculpted inboard faces 40b form the U-shaped coolant channels 32a-32d. Specifically, the coolant channels 32a, 32b, 32c, 32d indicated in FIG. 2 are formed by an arrangement of nested pairs U-shaped recesses 42a, 42b, 42c, 42d on the inboard face 40b of each inner frame member 24a, 24b. The opposed recesses 42a-42d on the inboard faces 40b of frame members 24a and 24b abut when the frame members 24a and 24b are joined, thereby defining the U-shaped coolant channels 32a-32d, including the respective entry end 54 and exit end 56 of each coolant channels 32a-32d. The inner frame members 24a, 24b also include lower openings or apertures 44 that align as indicated to form the intake chamber 28 and exhaust chambers 30A and 30B mentioned above in reference to FIG. 2. The recesses 42a-42d open at one end into the openings 44 that form the intake chamber 28, and at the other end into the openings 44 that form the exhaust chambers 30A and 30B to produce the coolant flow illustrated in FIG. 4 when coolant is supplied to the inlet port 20a. A tongue-in-groove seal 46 near the periphery of the inner frame members 24a, 24b prevents coolant leaks to atmosphere; and tongue-in-groove seals 52 helps prevent short-cut coolant leakages between intake plenum 34 and exhaust plenums 36A and 36B. It is expected that some coolant leakage between adjacent coolant channels 32a and 32b, or between adjacent coolant channels 32c and 32d may occur, but any such leakage is expected to be both minor and inconsequential.

The battery cells 26a, 26b are maintained in contact with the smooth and planar outboard faces 40 of the inner frame members 24a, 24b, and the coolant in coolant channels 32a-32d is only separated from the battery cells 26a, 26b by the local thickness of the respective inner frame member 24a or 24b, which may be on the order of 1 mm or less. Accordingly, heat produced by the battery cells 26a, 26b is quickly and efficiently transferred to the coolant flowing in coolant channels 32a-32d, even if the inner frame members 24a, 24b are constructed of a material such as plastic. Of course, the inner frame members 24a, 24b could be constructed of a material exhibiting high thermal conductivity if desired. Also, it is possible to utilize an insulating material such as plastic for the marginal portions of inner frame members 24a, 24b, and a conductive material such as aluminum for the non-marginal portions of inner frame members 24a, 24b.

The two outer frame members 24c and 24d fasten to the inner frame members 24a and 24b, respectively, to retain the prismatic battery cells 26a and 26b in the module 14. In effect, the terminal and marginal portions of each battery cell 26a, 26b are sandwiched between an inner frame member 24a, 24b and an outer frame member 24c, 24d. And the inter-module foam pads, mentioned above in respect to FIG. 1, press against the exposed non-marginal portions of the battery cells 26a and 26b to maintain them in abutment with the exterior surfaces 40 of the inner frame members 24a and 24b.

In summary, present invention provides an effective and low-cost packaging arrangement for efficiently and uniformly cooling a prismatic-cell battery pack with a flow-through coolant. Integrating the coolant channels 32a-32d and plenums 34, 36 into the frames 24a, 24b that support the cells 26 of the battery pack 10 contributes to low overall cost, and ensures that the coolant will uniformly cool each of the cells 26. The use of identical parts in reverse orientation (for example, the inlet and outlet end caps 20, 22, the inner frame members 24a, 24b, and the outer frame members 24c, 24d) also contributes to low overall cost of the battery pack 10. The ‘up-the-middle, down-the-outside’ configuration of the flow channels 32a-32d helps to deliver lower temperature coolant to the central area of the battery cells where the highest temperatures have been observed, and as such provide for more uniform operating temperatures across the battery cells.

While the present invention has been described with respect to the illustrated embodiment, it is recognized that numerous modifications and variations in addition to those mentioned herein will occur to those skilled in the art. For example, the number of coolant channels 32a-32d in a battery cell module 14 may be different than shown, as may the number of battery cells 26 in a battery cell module 14, or the entry end 54 of coolant channels 32a and 32d may be joined to form a common inlet end overlying the center line 50 to form a ‘T’ shaped coolant channel, and so on. Accordingly, it is intended that the invention not be limited to the disclosed embodiment, but that it have the full scope permitted by the language of the following claims.

We claim:

1. A prismatic-cell battery pack, comprising:
a set of battery cell modules arranged and interlocked in a lineal stack, wherein each battery cell module includes at least one prismatic battery cell supported in thermal contact with one or more coolant channels distributed over a profile surface of the battery cell, and a plurality of peripheral chambers joined to opposite ends of the coolant channels configured to form an intake plenum and a pair of exhaust plenums respectively upstream and downstream of the coolant channels when the modules are lineally arranged and interlocked, wherein each coolant channel defines an entry end coupled to the intake plenum and one or more exit ends coupled to one or both of exhaust plenums, whereby coolant supplied to the intake plenum enters the entry end of a channel and is returned to one or more exhaust plenums via one or more the exit ends for expulsion from the battery pack, and thereby cools the respective battery cells, wherein the entry end is closer to a centerline of the battery cell than the exit end.

2. The prismatic-cell battery pack of claim 1, wherein said entry end establishes an entry coolant flow direction parallel to an exit flow direction established by the exit end.

3. The prismatic-cell battery pack of claim 1, wherein said intake and exhaust plenums are disposed near a first end of the battery cell, and the coolant channels of each module conduct coolant from the intake plenum toward a second end of the battery cell and then back into the at least one of the pair of exhaust plenums.

4. The prismatic-cell battery pack of claim 1, wherein said prismatic-cell battery pack further comprises
a coolant inlet cap that blocks the pair of exhaust plenums and defines a coolant inlet pathway between the intake plenum and an inlet port defined by the coolant inlet cap; and
a coolant outlet cap that blocks the intake plenum and defines a coolant outlet pathway between the exhaust plenum and an outlet port defined by the coolant outlet cap.

5. The prismatic-cell battery pack of claim 1, wherein said battery cell modules further comprise
first and second prismatic battery cells; and
first and second mutually joined inner frame members having sculpted inboard faces that form the one or more coolant channels, and planar outboard faces that are thermally coupled to the first and second battery cells.

6. The prismatic-cell battery pack of claim 5, wherein said first and second inner frame members have peripheral openings that form the pair of peripheral chambers.

7. The prismatic-cell battery pack of claim 6, wherein said prismatic-cell battery pack further comprises a peripheral seal between the first and second inner frame members to prevent coolant leakage from the array of coolant channels and the peripheral chambers.

8. The prismatic-cell battery pack of claim 5, wherein said prismatic-cell battery pack further comprises a seal between the first and second inner frame members to prevent coolant leakage between the pair of peripheral chambers.
